(19) United States
(12) Patent Application Publication
(10) Pub. No.: US 2026/0238927 A1
(43) Pub. Date: Aug. 13, 2026

(54) SYSTEM AND METHOD FOR A SPLIT-GAP AUDIO TRANSDUCER

(71) Applicants: RYAN METTLER, KIRKLAND, WA (US); Timothy Whitwell, KIRKLAND, WA (US)

(72) Inventors: RYAN METTLER, KIRKLAND, WA (US); Timothy Whitwell, KIRKLAND, WA (US)

(73) Assignee: TECTONIC AUDIO LABS, INC., KIRKLAND, WA (US)

(21) Appl. No.: 19/422,426

(22) Filed: Dec. 16, 2025

Related U.S. Application Data
(60) Provisional application No. 63/734,700, filed on Dec. 16, 2024.

(51) Int. Cl. H04R 9/06; H02K 41/035; H04R 1/02; H04R 7/02; H04R 9/02; H04R 9/04

(52) U.S. Cl. CPC H04R 9/06; H02K 41/0354; H04R 1/025; H04R 7/02; H04R 9/025; H04R 9/046

(57) ABSTRACT

An electromagnetic motor for an audio transducer comprising a housing, a first magnet, a second magnet, a first pole piece, a second pole piece, a first voice coil in a first air gap, a second voice coil in a second air gap, the first voice coil coupled to a first diaphragm and the second voice coil coupled to a second diaphragm, the first voice coil vibrationally driving the first diaphragm to emit an audio signal in a first direction in response to an electrical signal and a magnetic field in the first air gap, the second voice coil vibrationally driving the second diaphragm to emit the audio signal in a second direction in response to the electrical signal and the magnetic field in the second air gap, the motor acoustically balancing the driving of audio signal emissions from the diaphragms in both the first direction and the second direction.

### CROSS-REFERENCE TO RELATED APPLICATION

This application claims priority to co-owned and co-pending U.S. Patent Application No. 63/734,700, of the same title filed Dec. 16, 2024, which is incorporated herein by reference in its entirety.

### FIELD

The present disclosure relates generally to the field of audio systems and, in particular but not exclusively, relates to an acoustic transducer having a split-gap motor design that can reproduce bass frequencies in a small, compact enclosure.

### BACKGROUND

Good bass performance is hard to achieve in a small device. Thin devices like televisions and soundbars are highly constrained in one or more dimensions. Portable speakers are often constrained in total enclosure volume but place a premium on bass extension. When speaker volume is constrained, more power and specialized audio transducers are required.

The enclosure volume of a small speaker acts like an air spring on an audio transducer's diaphragm. A smaller diaphragm will have smaller air spring force exerted on it by the enclosure, but it will need to travel farther to displace the same amount of air. In most size constrained applications, the audio transducer operates below its box tuning frequency, which is commonly referred to as the “stiffness dominated region” since the audio transducer's suspension and the air stiffness from the enclosure of a small speaker dominate the efficiency behavior. By operating a small speaker below its box tuning frequency, an optimal diaphragm size can be determined for a given motor efficiency.

The low frequency performance limit of an audio transducer is generally determined by the volume of air the diaphragm can displace before audible distortion can be heard. There are a few mechanisms that generate distortion but the most critical is determined from the consistency of the variation in magnetic force factor (referred to as “BL”) with voice coil motion. BL decreases as the voice coil is axially displaced out of the high flux density region between the pole piece and the motor housing. In alternate motor configurations, this would occur between the top plate and the yoke of an audio transducer. Once the BL has decreased to 82% of its at rest value, the audio transducer will produce undesirable distortion exceeding 10% of the level of the fundamental of the oscillatory signal, and the output is considered nonlinear for voice coil displacements in excess of this value. A voice coil displacement where 10% distortion is generated is referred to as the maximum linear excursion (referred to as “Xmax”). To account for inward and outward motion, Xmax is more precisely the minimum distance between the voice coil rest position and where the BL reaches the 82% limit in either the inward or outward axial direction. A key metric for determining the low frequency performance of an audio transducer is to multiply the Xmax by the total radiating area of the audio transducer to thereby determine a volume of linear displaced air.

Implementation of split-gap designs, where the magnetic flux is steered around and through the coil in a way that maximizes Xmax, also reduces the amount of magnetic flux passing through the voice coil at its rest position. This is usually achieved by adding one or more notches to a pole piece, a top plate, or a motor housing. The reduced rest position flux will decrease the BL of the audio transducer because the flux passing through the voice coil is directly proportional to the amount of force the coil will generate for a given amount of electrical current.

Another determining factor for low frequency performance is the damping of the audio transducer. There is both mechanical and electromagnetic damping in audio transducers, but electromagnetic damping is usually dominant. The higher the value of the expression BL²/Re, the greater the electromagnetic damping of the loudspeaker (here “Re” is the direct current resistance of the voice coil). This relationship is commonly referred to as “shove.” A higher shove allows the audio transducer to reproduce low frequencies in a small enclosure size more efficiently and with less frequency dependent amplitude variations. Additional radiating elements like ports and passive radiators require high damping to be implemented effectively.

Compact audio transducer designs that utilize a single magnetic circuit to drive two mutually opposed diaphragms have high shove and diaphragm radiating area. The shared motor design allows for more effective use of the magnets and the dual voice coils have a higher combined shove than a single motor audio transducer of the same size. Mechanical vibration sensitive applications that are also size constrained may necessitate the use of these shared motor designs as they are internally force balanced, thus substantially reduce transmitted vibrations. These designs are limited in their total mechanical excursion and Xmax because they are height constrained. Thus, the linear displaced air volume is restricted, limiting bass performance.

Hence, there is a growing need for audio transducers that have a high level of linear displaced air while also maintaining a high BL with a compact size and force balanced characteristics. By combining the high shove and high diaphragm area of a shared motor force balanced audio transducer with the high linear excursion of a split-gap motor design, an audio transducer can be created to efficiently reproduce audio bass frequencies in a small enclosure.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a cross-sectional view of a motor for a split-gap balanced audio transducer in an embodiment.

FIG. 2 is a cross-sectional view of a motor for a split-gap balanced audio transducer in an alternative embodiment.

FIG. 3 is a cross-sectional view of a motor for a split-gap balanced audio transducer in an alternative embodiment.

FIG. 4A is an illustration of a normalized radial magnetic field (“B-field”) profile of a split-gap motor design in an embodiment.

FIG. 4B is an illustration of a normalized magnetic force factor (“BL”) profile of a split-gap motor design in an embodiment.

FIG. 5 is cross-sectional view of magnetic field lines on a split-gap balanced audio transducer in an embodiment.

FIG. 6A is an illustration of a normalized radial B-field profile relative to coil wind height for split-gap motor designs in alternative embodiments.

FIG. 6B is an illustration of a normalized BL profile relative to coil wind height for split-gap motor designs in alternative embodiments.

FIG. 7A is a cross-sectional view of magnetic field lines on a split-gap motor design in an embodiment.

FIG. 7B is a cross-sectional view of magnetic field lines on an alternative split-gap motor design in an embodiment.

FIG. 8A is an illustration of a normalized radial B-field profile relative to coil wind height for split-gap motor designs in alternative embodiments.

FIG. 8B is an illustration of a normalized BL profile relative to coil wind height for split-gap motor designs in alternative embodiments.

### DETAILED DESCRIPTION

In the description to follow, various aspects of embodiments of split-gap motor audio transducers will be described, and specific configurations will be set forth. Numerous and specific details are given to provide an understanding of these embodiments. The aspects disclosed herein can be practiced without one or more of the specific details, or with other methods, components, systems, services, etc. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification do not necessarily all refer to the same embodiment. Furthermore, particular features, structures, or characteristics may be combined in any suitable manner in one or more embodiments.

Terminology used for the purpose of describing particular aspects only is not intended to be limiting of the subject matter disclosed herein. Spatially relative terms, such as “beneath”, “below”, “lower”, “above”, “upper”, and the like may be used herein for ease of description of relationships between elements or features, as illustrated in the accompanying figures. It is to be understood that spatially relative terms are intended to encompass different orientations of the apparatus in use or operation in addition to the orientation depicted in the figures. For example, if the apparatus in the figures is turned over, elements described as “below” or “beneath” other elements or features would then be oriented “above the other elements or features. Thus, the exemplary term “below” can encompass both an orientation of above and below. The apparatus may be otherwise oriented (e.g., rotated 90 degrees or at other orientations) and the spatially relative descriptors used herein are to be interpreted accordingly. In addition to spatially relative descriptors, it is also to be understood by those skilled in the art that the operation of the various embodiments of electromotive motors presented herein is preserved even when the polarity of the magnets used in these various embodiments are collectively swapped.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements and/or components, but do not preclude the presence or addition of one or more other features, steps, operations, elements, components, and/or groups thereof.

The terms “or” and “and/or” as used herein are to be interpreted as inclusive or meaning any one or more combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

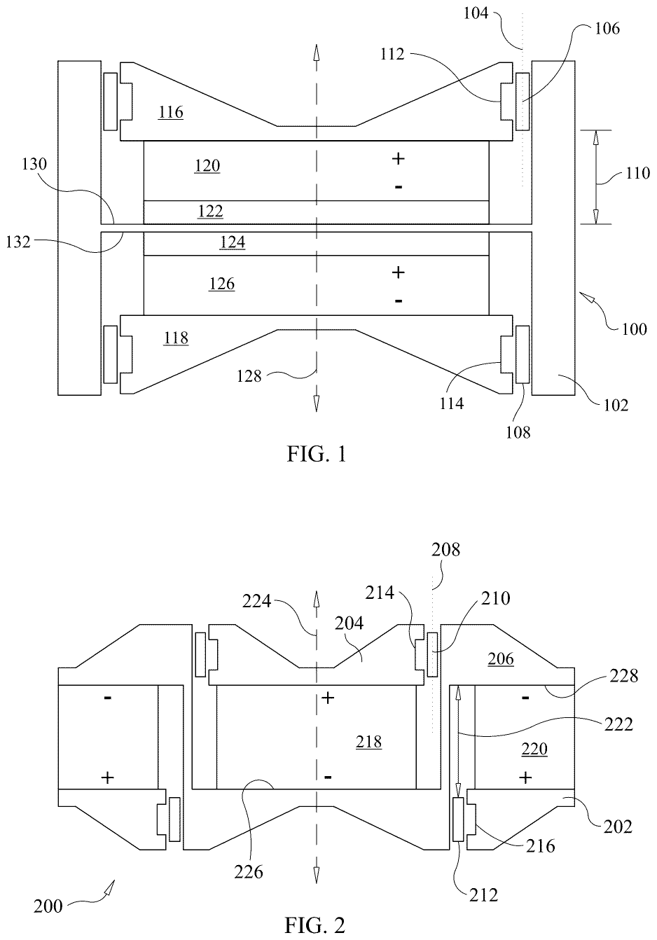

In the description of the embodiments shown in FIGS. 1, 2 and 3 to follow, a split-gap magnetic structure with a force-balanced dual-diaphragm electromotive motor configuration utilizing a shared magnetic circuit is described. As used in this disclosure, several terms are used with specific relevance to the embodiments presented herein. Specifically, the term “air gap” means the region of space defined by a pole piece, a magnet, and a housing that provides a voice coil clearance to move during operation of an electromotive motor. The term “gap” means a narrow region of high magnetic flux density in an electromotive motor between a pole piece and a housing where a voice coil moves. A “split-gap” means two or more narrow regions of high magnetic flux density are vertically positioned within an air gap such that a voice coil at its rest position is within one or more high flux density regions at the same time. In the disclosed embodiments, two voice coils are positioned along the same axis within the same magnetic circuit, and are wired to move in antiphase motion, achieving balance of the electromotive forces within the motor, and resulting in a force balanced audio transducer. This dual-coil, dual-diaphragm configuration with the added linear excursion benefits of a split-gap structural arrangement enables high linear displaced air volume (i.e., enhanced performance in the audio bass frequency range) and reduced voice coil translation-related distortion in a small, compact form factor that surpasses the performance of traditional single-gap or single-coil designs.

Although certain aspects of force balanced audio transducers and split gap magnetic architectures may appear individually in other contexts, the specific arrangements, geometry, and functional interactions described here are neither taught nor suggested by prior art. In particular, the combination of a shared motor, dual-diaphragm force balanced architecture with a split gap magnetic circuit configured to maximize linear excursion while preserving high BL at the resting coil position departs from established design teachings and yields results previously unattainable in compact loudspeaker systems.

Conventional shared-motor, force balanced audio transducers emphasize high magnetic force factor (BL), high electromagnetic damping (BL²/Re), and minimized motor height. These devices are inherently constrained in the axial dimension, limiting the mechanical excursion (X_{mech}) achievable in compact form factors. The high efficiency and compact size make them ideal for use in highly size constrained battery-operated devices like laptops, cell phones, and hearing aids. The shared motor, force balanced audio transducers are conventionally used as micro-speakers and miniature transducers where efficiency is usually prioritized above all other considerations.

In contrast, the known behavior of split-gap structures is that they reduce magnetic flux density at the voice coil rest position, resulting in BL degradation and efficiency loss. As discussed above, BL reduction has been the primary reason split-gap techniques have not been adopted in most loudspeakers, as the reduced rest-position BL adversely affects damping, efficiency, and low-frequency control. Accordingly, one of ordinary skill in the art would have understood these two technologies, shared-motor architectures and split-gap magnetic circuits, to be incompatible.

In a shared motor configuration, magnet field lines have opposite polarity in the air gap of the upper vs lower motor sections. To produce antiphase motion of the diaphragms, current must flow in the same direction for both voice coils. Conventional transducer design teaching suggests that this would be problematic due to the coupled magnetic fields produced by these two coils, as they can more easily modulate the B-field generated by the permanent magnets. Furthermore, a split gap motor architecture often suffers from low magnetic saturation in the pole piece due to its large size. Conventional teaching would suggest that the combination of split gap architecture and shared motor with opposing diaphragms would be incompatible due to high flux modulation distortion. However, in practice the shared motor structure leads to slightly more pole piece saturation and thus reduced flux modulation.

In a finite element analysis study of different motor configurations with fixed magnetic material volume, voice coil clearance for each voice coil, and motor stack height, various performance metrics were evaluated including BL²/Re, Xₘₐₓ, average pole piece saturation, and BL modulation for a set amount of power input to each voice coil. Shared motor versus the conventional single sided designs were evaluated. In the conventional single sided designs, only half the magnetic material is used, and the total motor stack is adjusted for an appropriately designed backplate thickness.

| | Magnet | Motor Stack | X_{mech} |
|---|---|---|---|
| | Volume (cm³) | Height (mm) | (mm) |
| Conventional | 13.5 | 28 | 12 |
| Shared Motor | 27 | 42 | 12 |

Shared motor designs experience less flux modulation compared to the conventional implementations. This indicates that counterintuitively the two voice coils in the shared motor designs generally modulate the B-field less than a single voice coil in the corresponding equivalent conventional designs. This could be caused by the lack of a back plate and generally a higher ratio of magnetic material to ferrous material.

While the shared motor split-gap has less electromagnetic damping, as defined by the ratio BL²/Re, relative to other shared motor designs, it has greater damping than any of the conventional designs. This allows it to provide good low frequency alignments while also having greater Xₘₐₓ than the other options for a given motor stack height and thus total transducer thickness.

| | | | Pole Piece | BL |
|---|---|---|---|---|
| | | Xₘₐₓ | Saturation | Modulation |
| | BL²/Re | (mm) | (T) | (+/−100 W) |
| Conventional Overhung | 22.4 | 4.3 | 1.406 | 5.26% |
| Conventional | 24.9 | 3.9 | 1.310 | 7.42% |
| Underhung | | | | |
| Conventional Split-Gap | 20.1 | 4.8 | 1.395 | 7.38% |
| Shared Motor Overhung | 44.4 | 4.3 | 1.410 | 5.10% |
| Shared Motor | 50.0 | 3.9 | 1.312 | 7.37% |
| Underhung | | | | |
| Shared Motor Split-Gap | 40.3 | 4.8 | 1.396 | 7.29% |

A first embodiment 100 of an electromotive motor for a split-gap force balanced audio transducer is shown in FIG. 1. A first voice coil 106 is suspended in an air gap formed between a vertical portion of a magnetically permeable housing 102 oriented in a first vertical direction, a first magnetically permeable pole piece 116, a first magnet 120, and an optional first magnetically permeable spacer 122 mounted on a first horizontal surface 130 of the housing 102. A second voice coil 108 is suspended in a second air gap formed between a vertical portion of the magnetically permeable housing 102 oriented in a vertical direction that is opposite the first vertical direction, a second magnetically permeable pole piece 118, a second magnet 126, and a second optional magnetically permeable spacer 124 mounted on a second horizontal surface 132 of the housing 102. Each voice coil 106, 108 is coupled to a diaphragm (not shown) and vibrationally move in opposing directions. In operation, the maximum distance travelled from the rest position by each voice coil 106, 108 is the mechanical excursion limit (referenced herein as “X_{mech}”). To allow for sufficient clearance within the motor assembly, the first voice coil 106 and the second voice coil 108 are positioned at a distance that is the mechanical excursion limit above the first horizontal surface 130 and the second horizontal surface 132, respectively, of the magnetically permeable housing 102.

The first magnet 120 is placed in a first spatial region defined by the housing 102 between the first pole piece 116 and the first magnetically permeable spacer component 122 with a first magnetic orientation. A first notch 112 is created in a first pole piece 116 and a second notch 114 is created in a second pole piece 118 to increase the consistency of magnetic flux passing through the voice coil for different coil positions within the air gaps. The second magnet 126 is placed in a second spatial region defined by the housing 102 between the second pole piece 118 and the second magnetically permeable spacer component 124 with a magnetic orientation that is the same as the first magnetic orientation. As is known by those of ordinary skill in the art, a magnet generates a magnetic field having multiple dimensional components, including a radial component and an axial component. By having the same magnetic orientations, the direction of flow of the magnetic fields in the first spatial region of the housing 102 and the second spatial region of the housing 102 are magnetically the same in this first embodiment. The direction of flow of magnetic field lines in the portion of the electromotive motor for a split-gap force balanced audio transducer 100 to the right of the axis of symmetry 128 is in the clockwise direction. As a result, the various components of the magnetic field lines emanating from the north pole of the first magnet 120 in the first spatial region of the housing 102 extend through the first pole piece 116, across the first air gap including the first voice coil 106, into the vertical portion of the housing 102, across the air gap including the second voice coil 108, through the second pole piece 118 to the south pole of the second magnet 126. Additionally, the magnetic field lines emanating from the north pole of the second magnet 126 in the second spatial region of the housing 102 extend through the second magnetically permeable spacer component 124, across the housing 102 into the first spatial region of the housing 102, and through the magnetically permeable spacer component 122 to the south pole of the first magnet 120. In this manner a single magnetic circuit is formed as an electrodynamic motor that provides a magnetic field for both voice coils 106, 108 to be vibrationally driven with equal force in opposite directions to thereby enable the transmission of comparable acoustic energy from opposite sides of an acoustic transducer.

An alternative embodiment 200 for a split-gap force balanced audio transducer is shown in FIG. 2. In this embodiment, a first voice coil 210 is suspended in an air gap defined between a pole piece 204, a first magnet 218 and a first spatial region of a housing 206. As illustrated, the housing 206 defines a first spatial region having a first horizontal surface 226 upon which the first magnet 218 is placed. The housing 206 also defines a second spatial region with a second horizontal surface 228 upon which a second magnet 220 is placed in a magnetic orientation that is opposite the magnetic orientation of the first magnet in the first spatial region of the housing 206. In the second spatial region, a second air gap is defined into which a second voice coil 212 is placed. The second air gap is defined by a top plate 202, a vertical section of the housing 206, and the second magnet 220. The south pole side of the second magnet 220 is placed upon the second horizontal section 228 of the housing 206 defining the second spatial region. In contrast, the south pole side of the first magnet 218 is placed upon the first horizontal surface 226 of the housing 206 defining the first spatial region. The pole piece 204 is placed upon the north pole side of the first magnet 218 while the top plate 202 is placed upon the north pole side of the second magnet 220. Collectively, the pole piece 204 and the first magnet 218 are placed within the first spatial region defined by the housing 206 while the top plate 202 and the second magnet 220 are placed within the second spatial region defined by the housing 206. A first notch 214 is created in the pole piece 204 and a second notch 216 is created in the top plate 202 to increase the consistency of magnetic flux passing through the voice coil for different coil positions within the air gaps. As oriented in this embodiment, each voice coil 210, 212 are in vibrational motion in independent air gaps and, as such, have greater independent excursion distances to travel while in vibratory motion. The direction of the magnetic field in the first spatial region originates from the north pole of the first magnet 218, through the magnetically permeable pole piece 204, across the first air gap in which the first voice coil 210 is suspended, through a first portion of the housing 206 to the south pole of the second magnet 220. Likewise, and in clockwise direction when observing on the right side of the axisymmetric line 224, a magnetic field originates from the north pole of the second magnet 220 through the top plate 202, across the second air gap in which the second voice coil 212 is suspended, into a second portion of the housing 206 to the south pole side of the first magnet 218. In the illustrated embodiment, each voice coil 210, 212 is positioned within an air gap at the mechanical excursion distance 222 from the first horizontal surface of the housing 226 and the second horizontal surface of the housing 228, respectively. Optionally, a magnetically permeable spacer can be added between the first magnet 218 and the first horizontal surface 226 of the housing 206 as well as between the second magnet 220 and the second horizontal surface 228 of the housing 206. A spacer may be added in either location or in both locations in order to limit the size of each magnet when added magnetic material does not appreciably enhance the strength of the magnetic flux density in each split-gap region, or if additional mechanical excursion distance is required. Additionally, the first magnet 218 is located radially inward from the second magnet 220 and is smaller in volume. Because of this, the first magnet 218 is typically comprised of a higher grade of magnetic material than the second magnet 220. The first magnet 218 typically is made from a neodymium magnetic material and the second magnet 220 is typically made from either a lower grade of neodymium magnetic material or of a ferrite magnetic material.

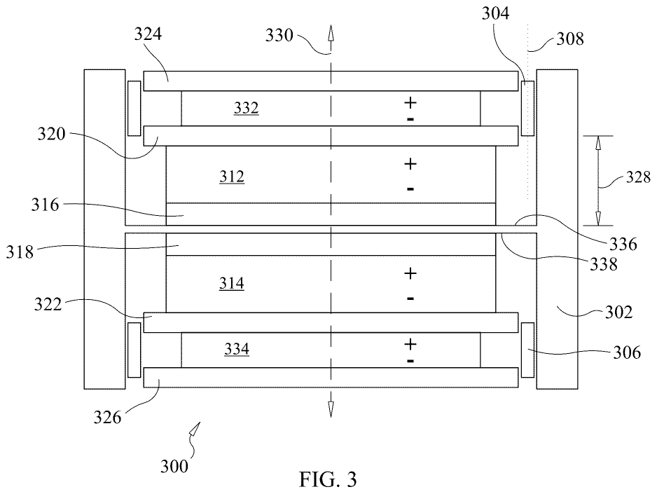

Yet another embodiment of a motor 300 for a split-gap force balanced audio transducer is shown in FIG. 3. In this embodiment, an auxiliary permanent magnet is added between two smaller pole pieces in the split-gap region. This structural arrangement equalizes the magnetic flux density across both high magnetic flux density regions, preventing an imbalance in magnetic flux densities that thick pole pieces would otherwise cause. The auxiliary magnet's polarity is aligned with the primary magnet's polarity, shortening the magnetic pathway and reducing magnetic flux modulation when high coil currents are present in voice coils. The result is improved symmetry of the magnetic flux within the high magnetic flux density regions, higher saturation of the pole pieces (preventing B-field modulation from the voice coil magnetic field), which in turn improves the linearity of force generation during dynamic drive conditions.

As shown in the depicted embodiment, the electromotive motor 300 is comprised of a housing 302 having two spatial regions, each spatial region defined by a vertical portion of the housing 302 and a horizontal portion, the horizontal portion having a first surface 336 and a second surface 338. In the illustrated embodiment, a first side of an optional magnetically permeable spacer component 316 can be mounted upon the first surface 336 of the horizontal portion of the housing in the first spatial region. A first side of a first magnet 312 is placed on a second side of the optional spacer 316, the first magnet 312 having a north-south magnetic orientation in an embodiment. A first split-gap magnet 332, also having a north-south magnetic orientation, is part of a composite sandwiched structure formed between a first pole piece 320 and a second pole piece 324 such that a first surface of the first split-gap magnet 332 is placed on a first surface of the first pole piece 320 and a second surface of the first split-gap magnet 332 is placed onto an inner surface of the second pole piece 324. The north-south orientation of the first magnet 312 is the same as the north-south orientation of the first split gap magnet 332. The radial length of the split-gap magnet, measured from an axisymmetric line 330, is less than the radial length of the first pole piece 320 and the second pole piece 324 in order to form a defined notch. The first voice coil 304 is placed proximate to the defined notch to ensure the first voice coil 304 is centered within the magnetic field produced from the first portion of the electromotive motor comprised of the first split-gap magnet 332 and the first permanent magnet 312, the optional spacer 316, the first pole piece 320, and the second pole piece 324. In selecting a split-gap magnet 332, 334, both the material and size of each magnet 332, 334 are adjusted to balance the magnetic flux passing through each of the two pole pieces 320, 324 in the first spatial region of the housing 302 and each of the two pole pieces 322, 326 in the second spatial region of the housing 302. The height, depth and shape of the defined notch is defined by the sandwiched structure comprised of the first pole piece 320, the second pole piece 324 and the split-gap magnet 332. This composite sandwiched structure is determined substantially by the desired magnetic flux symmetry, a target Xmax value, and the magnitude of the magnetic field to which a voice coil is to be exposed for a desired BL value to be used to vibrationally drive a diaphragm (not shown) coupled to a voice coil former upon which the first voice coil 304 is wound. An audio amplifier is electrically coupled to each voice coil 304, 306 and, in operation, the amplifier provides an amplified electrical signal that is carried by each voice coil 304, 306 which in turn affects the translational motion of the voice coils 304, 306 within the air gap. As illustrated, the first voice coil 304 travels within the air gap and in the presence of a magnetic field whose strength may vary at different locations along its travel path. Variations in the strength of the magnetic field over the path of travel of the first voice coil 304 may be detected along a radial B-field evaluation line 308.

Correspondingly, a combination of components are provided on the second surface of the horizontal portion 338 of the housing 302 in the second spatial region. Specifically, a first side of an optional magnetically permeable spacer 318 is placed onto the second surface 338 of the horizontal portion of the housing 302. The opposite side of the optional spacer 318 is placed on a first side of a second permanent magnet 314. The second side of the second permanent magnet 314 is placed onto the inner side of a third pole piece 322. A second split-gap magnet 334 is sandwiched between the outer side of the third pole piece 322 and the inner side of a fourth pole piece 326. The outer side of the fourth pole piece 326 is proximate to a diaphragm (not shown) that is vibrationally driven by the voice coil 306 which is wound upon a voice coil former (not shown). The second voice coil 306 is placed proximate to the defined notch to ensure the second voice coil 306 is centered within the magnetic field produced from the second portion of the electromotive motor comprised of the second split-gap magnet 334 and the second permanent magnet 314, the optional spacer 318, the third pole piece 322, and the fourth pole piece 326. The first and second portions of the magnetic circuit collectively form a single continuous magnetic circuit. It is to be noted again that all components comprising the motor 300 are placed in alignment with respect to a center line 330 with the components in the first spatial region aligned in a first direction and the components in the second spatial region aligned in a second direction that is opposite the first direction. The magnetic orientation of the second magnet 314 and the second split-gap magnet 334 in the second spatial region of the housing 302 is the same as the magnetic orientation of the first magnet 312 and the first split-gap magnet 332 in the first spatial region of the housing 302. The operation of the motor 300 thus involves the use of magnetics having the same magnetic orientations in opposite spatial regions to ensure equal and opposite magnetic field properties for each voice coil 304, 306. The second split-gap magnet 334 also has a radial length that this less than the radial length of the third pole piece 322 and the fourth pole piece 326 so that a defined notch can be formed by the second split-gap magnet 334, the third pole piece 322 and the fourth pole piece 326. Correspondingly, the height, depth and shape of the defined notch defined by the sandwiched structure comprised of the third pole piece 322, the fourth pole piece 326 and the second split-gap magnet 334 is determined substantially by the magnitude of the magnetic field to which the voice coil is to be exposed for the desired level of BL force to be used to vibrationally drive a diaphragm (not shown) coupled to a voice coil former upon which the second voice coil 306 is wound. In operation, the voice coil 306 travels within the air gap and in the presence of a magnetic field whose strength may vary at different locations along the travel path of the second voice coil 306.

The embodiment illustrated in FIG. 3 addresses a need in certain split-gap applications for a pole piece that is to be thicker (in the axial dimension) to accommodate a larger linear excursion distance when a goal of a magnetic circuit design is to equally distribute magnetic flux over at least two high magnetic flux density regions. In these cases, at least two equal high magnetic flux density regions can be created by using a sandwiched permanent magnet, referred to as a split-gap magnet (see elements 332 and 334 in FIG. 3), between two separate smaller pole pieces (see elements 320, 324, 322 and 326). These are two conventional pole pieces having thicknesses corresponding to un-notched portions of pole pieces in unequally distributed magnetic flux density motor arrangements. The outer diameter and in some cases inner diameter of a split-gap magnet and the grade of magnet may be adjusted to balance the amount of magnetic flux density flowing through the two pole pieces. Magnet thicknesses are set by the defined notch height, and the thickness of pole pieces and magnets are adjusted to create the desired high magnetic flux density regions. The split-gap magnets 332, 334 divert magnetic flux from the inner pole pieces 320, 322 into the outer pole pieces 324, 326 so reducing the diameter of the split-gap magnets 332, 334 will divert less magnetic flux. Additionally, using a lower remanence magnet material causes an equivalent effect. By adjusting and tuning the material and outer diameter of the split-gap magnets 332, 334, the level of magnetic flux density, can be equalized through multiple high magnetic flux density regions. In the embodiment illustrated in FIG. 3, the polarity of the magnets 312, 314, 332 and 334 are oriented in the same direction to achieve optimal magnetic flux density distribution.

A benefit of the embodiment of the motor 300 shown in FIG. 3, including the additional split-gap magnet, is its ability to limit the amount of magnetic flux modulation that can occur with high voice coil input currents. If a pole piece is predominantly undersaturated (which can occur in many split-gap motor designs), then the magnetic field generated by a voice coil can modulate the static magnetic field generated by the magnetic circuit. This modulation of the static magnetic field causes the force acting on a voice coil for a given current to be inconsistent, which can cause distortion. By adding a magnet between two pole pieces, the magnetic pathway can be shortened and the overall magnetic saturation in the pole pieces can be increased resulting in reduced modulation of the static magnetic field and a reduced level of modulation-related distortion.

In general, magnetic field lines flowing through an area create a magnetic flux density. The radial magnetic flux density measured or simulated in an audio transducer air gap will vary with observation location. If assessed at a radius halfway through the voice coil width, indicated by dashed line 104, 208 and 308 in FIGS. 1, 2 and 3, then a radial magnetic field (or “B-field”) profile can be ascertained. In the embodiment shown in FIG. 2, this is preferentially assessed at the locations of both voice coils 210 and 212 (upper and lower) as this embodiment is not vertically symmetrical so the B-fields will be different for the voice coils 210 and 212. For the embodiments shown in FIGS. 1, 2 and 3, as each voice coil moves through a B-field profile, it integrates the radial magnetic flux passing through the length of each voice coil and together they transduce current into an electromotive force as described by the Lorentz law. The magnetic force generated for an ampere of electrical current is referred to as “BL.” As each voice coil moves through the B-field, the amount of BL varies as the total radial magnetic flux captured by the coil varies. This is called the BL excursion profile, and it is used in the determination of the linear excursion range where the BL falls to 82% of its maximum (referred to as “Xₘₐₓ”).

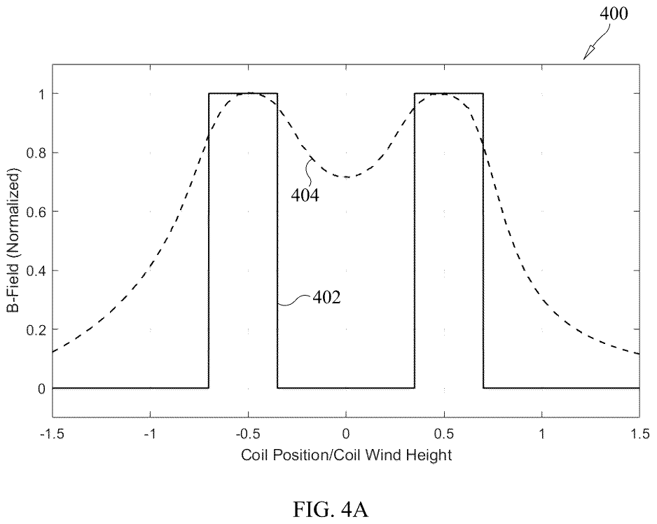

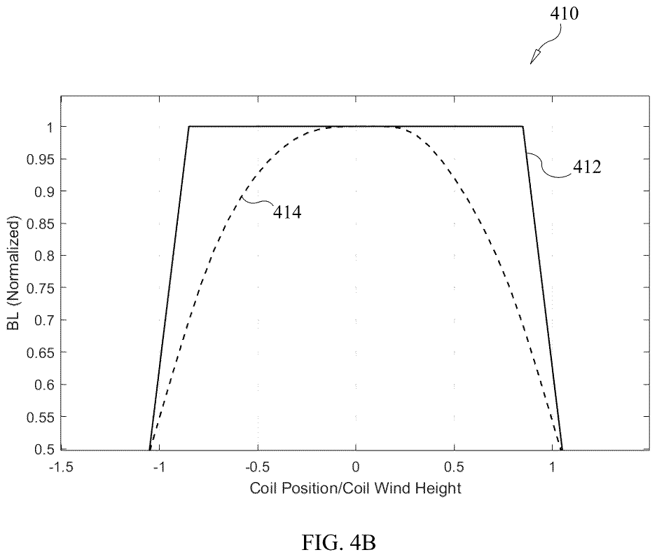

In order to maximize the consistency of the BL excursion profile, the radial component of the B-field should be locally reduced toward the center of a voice coil. In a representative illustration, a theoretical radial B-field profile consists of either one or zero (shown in FIG. 4A as a solid line 402). In FIG. 4A negative values for the normalized coil position (coil position/coil wind height) indicate voice coil travel towards the horizontal portion of the housing, and positive values for the normalized coil position indicate voice coil travel away from the horizontal portion of the housing. If a voice coil height is such that it extends halfway through the regions with a radial B-field value of 1, then the average magnetic flux passing through the voice coil will be constant until the bottom of the coil moves into the high magnetic flux density region in the positive voice coil movement direction or until the coil top moves into the high magnetic flux density region in the negative voice coil movement direction. The normalized theoretical BL linear excursion is shown for this case as a solid curve 412 in FIG. 4B. If the high magnetic flux density regions are narrowed around the top and bottom of the coil, then as the width approaches zero, the BL will remain constant for an entire coil height for movement in either direction. In contrast, the variation in radial B-field in a simulated operational embodiment of a motor implementing a split-gap design are shown in FIG. 4A as a dashed line 404. The corresponding variations in a normalized BL excursion profile for a simulated operational embodiment of a motor implementation are shown in FIG. 4B as a dashed line 414 which illustrates the variation as a voice coil shifts positions between a fully outward position to a fully inward position within an air gap. FIGS. 4A and 4B depict the results of a simulation of the magnetic fields flowing through and across a split-gap showing a dashed line to illustrate the difference between a theoretical radial B-field and BL excursion profile and the corresponding yield in simulated radial B-field and BL profiles of operational embodiments. While the theoretical cases yielded Xₘₐₓ of 0.92 H_{coil}, the simulated solution only gives 0.7 H_{coil}. To maximize Xₘₐₓ, the notch dimensions in a simulation may differ from the simulated case described above.

With a single notch split-gap design as shown in FIG. 1, the maximum linear excursion without a dip at the rest position is equal to the wind height of the coil. With a dual notch design, where there is a high magnetic flux density region at the coil rest position and high magnetic flux density regions centered at a voice coil height in either direction, the maximum limit is one and a half times the rest position. The inclusion of additional notches will have limited beneficial effect and corresponds with the coil height times the number of high magnetic flux density concentrations in the air gap divided by two. For large numbers of notches added to the pole piece, the Xmax advantage diminishes when compared to conventional coil motor designs (i.e. designs without notches). Therefore, it is best to limit the number of notches to one or two per pole piece. The following formula represents a more general form, where H_{coil} refers to voice coil height, Hₚ refers to the height of each unnotched portion of the pole piece and the number of notches is given by N_{notch}.

$${X}_{Max} = \frac{( {N}_{notch} + 1 )}{2} {H}_{coil} - \frac{{H}_{p}}{2}$$

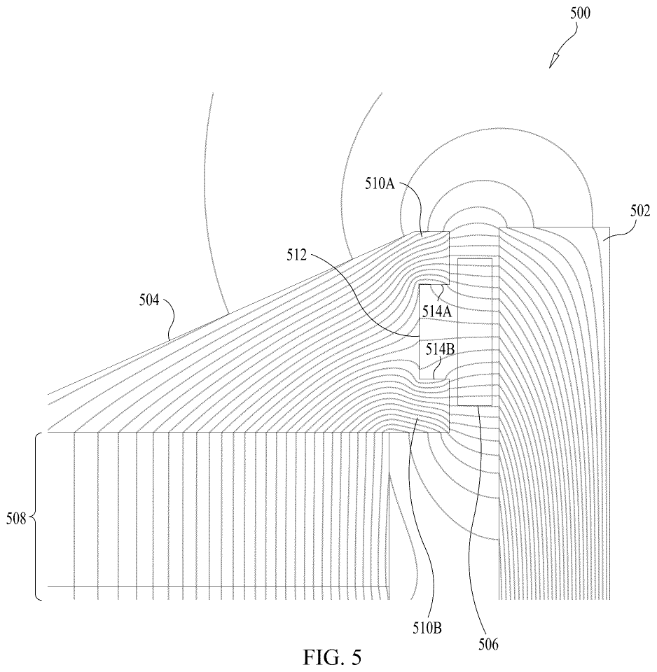

In practice, the slope of the radial B-field profile cannot be infinite and the radial B-field in the region of the air gap next to a notch will not be zero. The magnetic field lines forming the B-field profile in an illustration of the spatial relationship between a pole piece 504 and a housing 502 of a split-gap motor are shown in FIG. 5. As the magnetic field lines exit the pole piece 504, they spread outward, smoothing the shape of the observed B-field profile. As shown in this illustration, the pole piece 504 includes a notched region defined by a vertical side 512, a first horizontal side 514A and a second horizontal side 514B. The inclusion of a notch in the pole piece 504 defines an upper extended section 510A and a lower extended section 510B, each of which along with the vertical side 512 define the geometric dimensions of the notch. A voice coil 506 at its rest position is depicted in this illustration in position in the air gap defined between a housing 502, a magnet 508, and the “notched” pole piece 504.

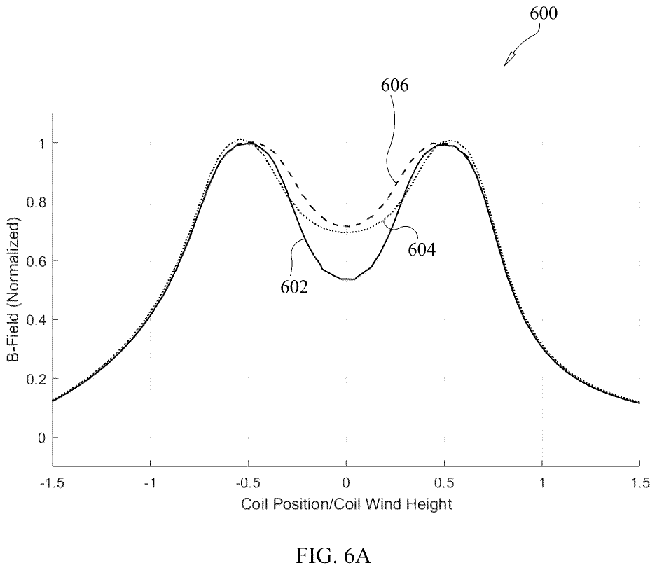

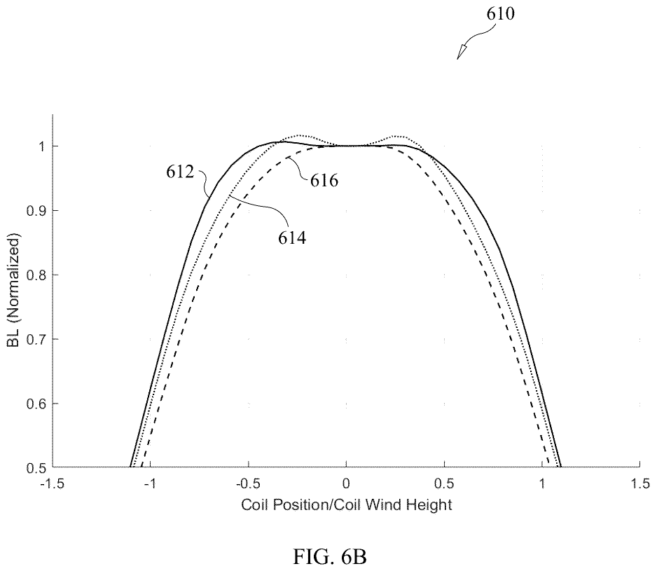

A smaller coil or a larger notch height can be used to achieve greater Xₘₐₓ. In FIGS. 6A and 6B, the dashed curves 606 and 616 show the radial B-field profile and corresponding BL excursion profile for a simulated split-gap motor system with one pole piece notch where the voice coil height extends halfway through the un-notched regions of the pole piece above and below the notch. The dotted curves 604 and 614 show the effect to the radial B-field and BL excursion profiles when the notch height is increased. Now the voice coil height only extends through one-third of the un-notched regions of the pole piece. The solid curves 602 and 612 show the effect to the radial B-field and BL excursion profiles when an equivalent notch is also added to the opposite side of the air gap onto the housing. The voice coil extends halfway through the un-notched portions of the pole piece in this embodiment. FIG. 6B, depicts the variation in normalized magnetic force factor (i.e., BL) relative to voice coil position (which is normalized to the voice coil wind height). In FIG. 6B While the Xₘₐₓ was increased to 0.75 H_{coil} the BL is no longer at its maximum at the voice coil rest position (see FIG. 6B), and actually is at a small local minimum. Alternatively, the solid curves show the effect of adding an identical notch to the far side of the air gap (i.e. into a housing), increases the Xₘₐₓ to 0.81 H_{coil}, and eliminates the rest position dip (also referred to as a local minimum).

Split-gap designs for force balanced audio transducers are based on design criteria that attempt to minimize the amount of BL (magnetic force) loss at the resting voice coil position while simultaneously maximizing Xₘₐₓ (i.e., linear excursion distance). The maximum excursion (X_{mech}) is the distance a voice coil can move inwards into a motor structure before some part of the moving assembly collides into the static parts of the audio transducer. The distance for the voice coil to crash into the housing is illustrated in FIGS. 1, 2 and 3 (as excursion distance 110, 222, 328). Required maximum excursion of the audio transducer is determined by the required maximum required SPL, total device radiating area, and minimum frequency of operation at the maximum SPL.

An added safety margin is required to achieve the designed sound pressure level (“SPL”). At least twenty percent (20%) more maximum excursion distance is recommended as safety margin over what is needed for a given SPL. For hemispherical radiation the expression is:

$${X}_{mech} = 1.2 \frac{\sqrt{2} {rP}_{Max}}{2 {π S}_{d} {ρ}_{air} {F}_{min}^{2}}$$

Where r is the listening distance, ρₐᵢᵣ is the density of air, P_{Max} is the maximum RMS desired output pressure, Sd is the total radiating area of both diaphragms and, Fₘᵢₙ is the minimum frequency where P_{Max} needs to be reached. For this approximation, it is assumed that both diaphragms radiate into the same hemispherical space.

For the required X_{mech}, the geometry constraints for the other components are given below. For every pole piece thickness there is a corresponding magnet height that provides the coil with enough clearance to reach maximum excursion. An optional spacer made from a magnetically permeable material may be added to occupy some of the available space for the magnet. The spacer should only be added to limit the amount of magnet material. This relationship is:

$${X}_{mech} = {H}_{magnet} + {H}_{spacer} + \frac{{H}_{pole} - {H}_{coil}}{2}$$

The voice coil height is selected by the linear excursion limit which is in turn selected based on the application. For distortion sensitive applications and applications with precise excursion control, the linear excursion limit can be closer to the maximum excursion limit. For safe operation in most applications the maximum excursion limit should be approximately double the desired linear excursion.

The pole piece and/or top plate heights are greater than the wind height of the voice coil. In cases where spacers are not used, as the pole height is increased, the magnet height is reduced. As this continues, the magnet will eventually become too small and the BL will drop. Likewise, there are pole and notch relationships that define a particular Xₘₐₓ. As the pole height is decreased, the notch height is typically increased to maintain a desired Xₘₐₓ. A smaller pole height is both practical from a manufacturing cost perspective and preferable for reducing overall audio transducer size. However, at some minimum pole height, the narrowed regions of high magnetic flux density will reduce the BL in the voice coil rest position. In between the extremes of having reduced BL from such a large pole height that the magnet size is reduced and having such a small pole height that can enable high magnetic flux density regions, there is a pole height and magnet height combination that optimally provides the maximum BL for a desired Xₘₐₓ. The pole piece and/or a top plate can be adjusted iteratively to find this optimal combination.

The height of the notch should be at least equal to the difference between two times the coil wind height and the pole piece height. The optimal notch depth for maximizing Xₘₐₓ is dependent on the air gap width, notch height and whether a notch is applied to the other side of the air gap as well.

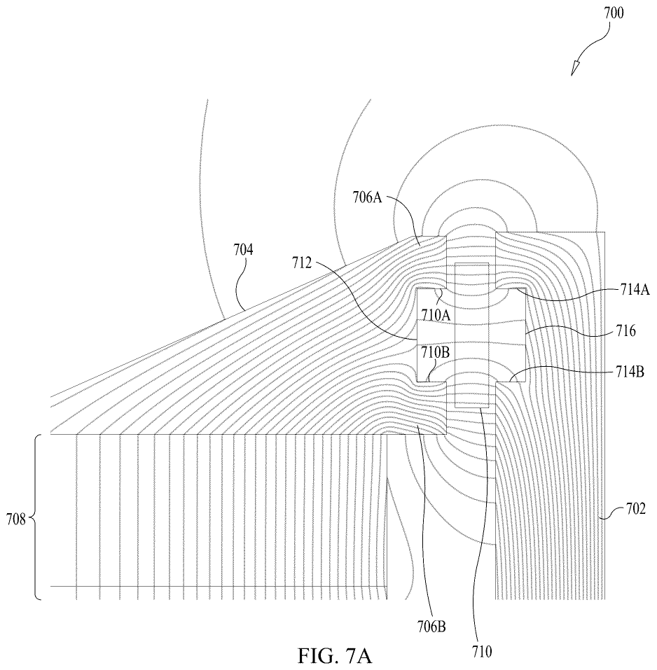

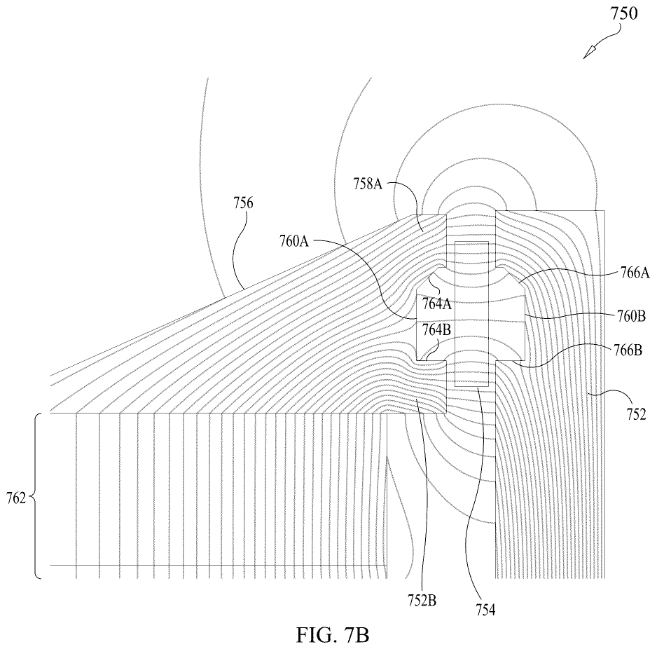

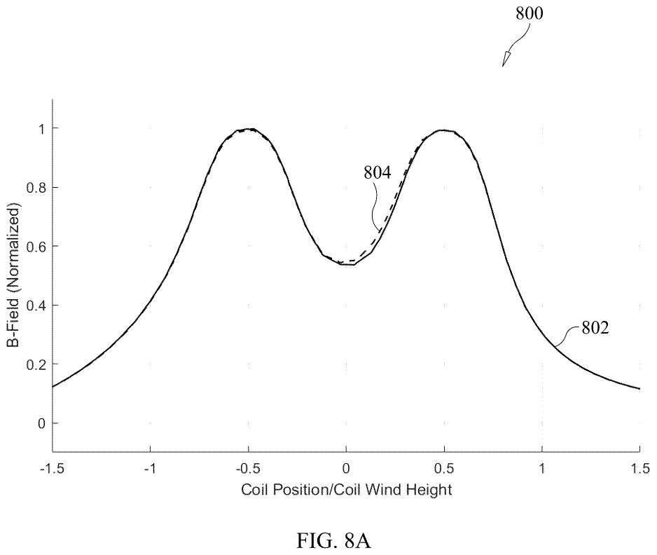

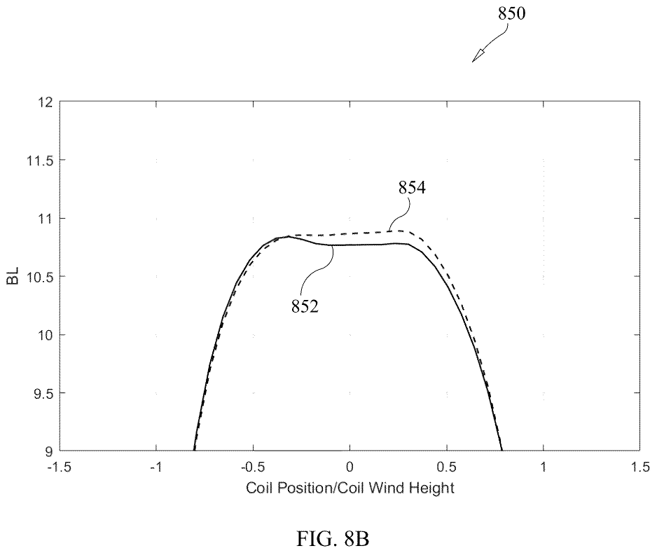

When the depth of the notch creates a magnetic constriction (region of high magnetic saturation) near the side of the notch farther from the magnet, the profile of the B-field lines extending from a magnet 708 will become asymmetrical about the resting position of the voice coil 710. FIG. 7A illustrates the regions of magnetic field line constriction within and around the pole piece 704 and the housing 702. These regions on the pole piece, 706A and 706B, are formed from a notch on the pole piece. Although the illustrated embodiment shows one notch, it should be understood by those skilled in the art that more than one notch can be included on the vertical side of the pole piece 704 and housing 702 to form multiple regions of magnetic field line constriction in a split-gap. On the pole piece 704, the rectangular notch is comprised of a first horizontal side 710A, an extended vertical side 712, and a second horizontal side 710B. Correspondingly, on the housing 702, a rectangular notch is provided which includes a first horizontal side 714A, a second horizontal side 714B and an extended vertical side 716, In FIG. 7B, a less magnetically constricted region is shown around an angled chamfer which is used to form an angled notch in both a pole piece 756 and a housing 752 which are proximate to the air gap into which the voice coil 754 is located. On the pole piece 756 the angled notch is comprised of a sloped side 764A, a horizontal side 764B and a vertical extended side 760A. On the housing 752, the angled notch is comprised of a sloped side 766A, an extended vertical side 760B and a horizontal side 766B The addition of a fillet or chamfer to the constricted portion of the pole piece 704 around the notch can decrease the magnetic saturation in the pole piece 704 and 756 and thereby improve the B-field symmetry at or near the rest position of a voice coil. This improvement reduces distortion due to an asymmetrical BL profile by maintaining consistent BL change during both inward and outward motion of each voice coil. FIGS. 8A and 8B show the corresponding radial B-field profile and BL profile for each of the alternative structures shown in FIGS. 7A and 7B. In FIG. 8A, the solid line 802 represents the radial B-field profile of the structure shown in FIG. 7A with the rectangular notch while the dashed line 804 represents the radial B-field profile of the structure shown in FIG. 7B which includes a notch having a chamfer. In FIG. 8B, the dashed line 854 illustrates a more symmetrical BL profile relative to coil position (normalized to coil wind height) in the magnetic field when the chamfer is in place when compared to a structure with no chamfer on either a pole piece or a housing, as shown by the solid line 852.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. An electromagnetic motor for an audio transducer, the motor comprising:
a housing comprised of a magnetically permeable material and having a vertical portion and a horizontal portion, the horizontal portion having a first surface and a second surface, the vertical portion and the horizontal portion defining a first spatial region and a second spatial region;
a first magnet having a first side and a second side, the first magnet placed in the first spatial region and having a magnetic orientation with a south-seeking pole on the first side, the first side placed upon the first surface of the horizontal portion of the housing;
a second magnet having a first side and a second side, the second magnet having a magnetic orientation in which a north-seeking pole on the first side is placed upon the second surface of the horizontal portion of the housing;
a first pole piece having a vertical side and placed in the first spatial region, the first pole piece placed upon the second side of the first magnet, the second side of the first magnet having a north-seeking pole of the magnetic orientation, the first pole piece having at least one notch on the vertical side of the first pole piece;
a second pole piece having a vertical side and placed in the second spatial region, the second pole piece placed upon the second magnet, the second side of the second magnet having a south-seeking pole of the magnetic orientation, the second pole piece having at least one notch on the vertical side of the second pole piece;
a first voice coil wound upon a first voice coil former, the first voice coil suspended in a first air gap defined between the first pole piece and the vertical portion of the housing, the first voice coil configured for translational movement within the first air gap in response to an electrical signal flowing in the first voice coil, the electrical signal generated from an audio amplifier; and
a second voice coil wound upon a second voice coil former, the second voice coil suspended in a second air gap defined between the second pole piece and the vertical portion of the housing, the second voice coil configured for translational movement within the second air gap in response to the generated electrical signal flowing in the second voice coil;
wherein the first voice coil is coupled to a first diaphragm and the second voice coil is coupled to a second diaphragm, the first voice coil being operative to vibrationally drive the first diaphragm for emission of an audio signal in a first direction in response to the electrical signal and a magnetic field in the first air gap, the second voice coil being operative to vibrationally drive the second diaphragm for emission of the audio signal in a second direction in response to the electrical signal and the magnetic field in the second air gap.

2. The electromotive motor of claim 1 wherein a radial component of the magnetic field extends across the first voice coil in the first air gap in a first magnetic direction between the first pole piece and the vertical portion of the housing, and wherein the radial component of the magnetic field extends across the second voice coil in the second air gap in a second magnetic direction, the second magnetic direction being opposite the first magnetic direction.

3. The electromotive motor of claim 2 wherein each notch of the at least one notch forms one or more regions in the first air gap having high magnetic flux density, the first voice coil experiencing a first electromotive force for driving a first diaphragm in a first vibrational direction in response to the generated electrical signal when placed in proximity to the one or more regions in the first air gap having high magnetic flux density.

4. The electromotive motor of claim 3 wherein each notch of the at least one notch forms one or more regions in the second air gap having high magnetic flux density, the second voice coil experiencing a second electromotive force for driving a second diaphragm in a second vibrational direction in response to the generated electrical signal when placed in proximity to the one or more regions in the second air gap having high magnetic flux density.

5. The electromotive motor of claim 1 further comprising a split-gap structure, the split-gap structure including at least two regions of high magnetic flux density between the vertical side of the first pole piece having the at least one notch and the housing, and at least two regions of high magnetic flux density between the vertical side of the second pole piece having the at least one notch and the housing.

6. The electromotive motor of claim 2 wherein a direction of electrical signal flow in the first voice coil is normal to a direction of the radially oriented magnetic field between the first pole piece and the housing, and wherein a direction of electrical signal flow in the second voice coil is normal to a direction of the radially oriented magnetic field between the second pole piece and the housing, the direction of electrical signal flow in the first voice coil being the same as the direction of electrical signal flow in the second voice coil.

7. The electromotive motor of claim 1 wherein the first pole piece, the first magnet and the vertical portion of the housing define the first air gap, and the second pole piece, the second magnet and the vertical portion of the housing define the second air gap.

8. The electromotive motor of claim 1 wherein the at least one notch on the first pole piece is one of a rectangular shape or a chamfered shape and defines at least two regions of high magnetic flux density.

9. The electromotive motor of claim 8 wherein the housing includes at least one notch that is one of a rectangular shape and a chamfered shape and is located across the first air gap from the at least one notch on the first pole piece.

10. The electromotive motor of claim 1 further comprising a spacer placed between the first side of the first magnet having the south-seeking pole and the horizontal portion of the housing, the spacer comprised of a magnetically permeable material.

11. The electromotive motor of claim 1 further comprising a spacer placed between the first side of the second magnet having the north-seeking pole and the horizontal portion of the housing, the spacer comprised of a magnetically permeable material.

12. An electromotive motor for an audio transducer, the motor comprising:
a housing comprised of a first spatial region and a second spatial region, the second spatial region being directionally opposite in spatial orientation from the first spatial region, each spatial region having a vertical side and a horizontal side;
a first magnet placed in the first spatial region, the first magnet having a first side and a second side, the first magnet having a magnetic orientation in which a south-seeking pole on the first side is placed on the horizontal side in the first spatial region;
a second magnet placed in the second spatial region, the second magnet having a first side and a second side, the second magnet having a magnetic orientation in which a south-seeking pole on the first side is placed on the horizontal side in the second spatial region;
a pole piece placed on the first magnet, the pole piece having a vertical side, the pole piece placed on the second side of the first magnet in the first spatial region, the second side of the first magnet having a north-seeking pole of the magnetic orientation, the vertical side of the pole piece having at least one notch;
a first voice coil wound upon a first voice coil former and suspended in a first air gap in the first spatial region, the first voice coil configured for translational movement within the first air gap in response to an electrical signal flowing in the first voice coil, the electrical signal generated from an audio amplifier; and
a second voice coil wound upon a second voice coil former and suspended in a second air gap in the second spatial region, the second voice coil configured for translational movement within the second air gap in response to the electrical signal flowing in the second voice coil;
wherein the first voice coil is coupled to a first diaphragm and the second voice coil is coupled to a second diaphragm, each voice coil being operative to vibrationally drive each coupled diaphragm with antiphase motion as the electrical signal flows in the voice coil while a magnetic field flows across the first voice coil in the first air gap and the second voice coil in the second air gap.

13. The electromotive motor of claim 12 further comprising a top plate placed upon the second side of the second magnet having a north-seeking pole, the top plate having a vertical side including at least one notch, the second air gap defined between the top plate, the horizontal side of the housing, and the second magnet.

14. The electromotive motor of claim 13 wherein a radial component of the magnetic field extends across the first voice coil in the first air gap in a first magnetic direction between the pole piece and the housing, and wherein the radial component of the magnetic field extends across the second voice coil in the second air gap in a second magnetic direction between the top plate and the housing, the second magnetic direction being opposite the first magnetic direction.

15. The electromotive motor of claim 12 wherein each notch of the at least one notch forms one or more regions on the pole piece having high magnetic flux density, the first voice coil experiencing a first electromotive force for driving a first diaphragm in a first vibrational direction in response to the generated electrical signal when placed in proximity to the one or more regions on the pole piece having high magnetic flux density.

16. The electromotive motor of claim 13 wherein the top plate is comprised of at least one notch on a vertical side of top plate, each notch of the at least one notch forming one or more regions on the top plate having high magnetic flux density, the second voice coil experiencing a second electromotive force for driving a second diaphragm in a second vibrational direction in response to the generated electrical signal when placed in proximity to the one or more regions on the top plate having high magnetic flux density.

17. The electromotive motor of claim 13 further comprising a split-gap structure, the split-gap structure including at least two regions of high magnetic flux density between the vertical side of the pole piece having the at least one notch and the housing, and at least two regions of high magnetic flux density between the vertical side of the top plate having the at least one notch and the housing.

18. The electromotive motor of claim 15 wherein the at least one notch on the pole piece is one of a rectangular shape or a chamfered shape and defines at least two regions of high magnetic flux density.

19. The electromotive motor of claim 18 wherein the housing includes at least one notch that is one of a rectangular shape and a chamfered shape and is located across the first air gap from the at least one notch on the pole piece.

20. The electromotive motor of claim 13 wherein the at least one notch on the top plate is one of a rectangular shape or a chamfered shape and defines at least two regions of high magnetic flux density in the second air gap.

21. The electromotive motor of claim 20 wherein the housing further comprises at least one notch that is one of a rectangular shape and a chamfered shape and is located across the second air gap from the at least one notch on the top plate.

22. The electromotive motor of claim 12 further comprising a spacer placed between the first side of the first magnet having the south-seeking pole and the horizontal portion of the housing, the spacer comprised of a magnetically permeable material.

23. The electromotive motor of claim 12 further comprising a spacer placed between the first side of the second magnet having the south-seeking pole and the horizontal portion of the housing, the spacer comprised of a magnetically permeable material.

24. An electromotive motor for an audio transducer, the motor comprising:
a housing comprised of a magnetically permeable material and having a vertical portion and a horizontal portion, the horizontal portion having a first surface and a second surface, the vertical portion and the horizontal portion defining a first spatial region and a second spatial region;
a first permanent magnet placed in the first spatial portion and having a first side and a second side, the first permanent magnet having a magnetic orientation with a south-seeking pole on the first side, the first side placed upon the first surface of the horizontal portion of the housing;
a second permanent magnet placed in the second spatial portion and having a first side and a second side, the second permanent magnet having a magnetic orientation with a north-seeking pole on the first side and a south-seeking pole on the second side, the first side placed upon the second surface of the horizontal portion of the housing;
a first composite structure comprised of an inner pole piece, a first split-gap magnet, and an outer pole piece, the first split-gap magnet having a north-seeking pole on a first side and a south-seeking pole on a second side, the outer pole piece placed on the first side of the first split-gap magnet, the inner pole piece having a first surface and a second surface, the first surface of the inner pole piece placed on the second side of the first split-gap magnet, the second surface of the inner pole piece placed on the second side of the first permanent magnet;
a second composite structure comprised of an inner pole piece, a second split-gap magnet, and an outer pole piece, the second split-gap magnet having a north-seeking pole on a first side and a south-seeking pole on a second side, the outer pole piece placed on the second side of the second split-gap magnet, the inner pole piece having a first surface and a second surface, the first surface of the inner pole piece placed on the first side of the second split-gap magnet, the second surface of the inner pole piece placed on the second side of the second permanent magnet;
a first voice coil wound upon a first voice coil former, the first voice coil suspended in a first air gap defined between the first composite structure and the vertical portion of the housing, the first voice coil configured for translational movement within the first air gap in response to an electrical signal flowing in the first voice coil, the electrical signal generated from an audio amplifier; and
a second voice coil wound upon a second voice coil former, the second voice coil suspended in a second air gap defined between the second composite structure and the vertical portion of the housing, the second voice coil configured for translational movement within the second air gap in response to the generated electrical signal flowing in the second voice coil;
wherein the first voice coil is coupled to a first diaphragm and the second voice coil is coupled to a second diaphragm, the first voice coil being operative to vibrationally drive the first diaphragm for emission of an audio signal in a first direction in response to the electrical signal as a magnetic field flows across the first voice coil in the first air gap, the second voice coil being operative to vibrationally drive the second diaphragm for emission of the audio signal in a second direction in response to the electrical signal as the magnetic field flows across the second voice coil in the second air gap.

25. The electromotive motor of claim 24 wherein a radial length of the first split-gap magnet is less than a radial length of each of the inner pole piece and the outer pole piece in the first composite structure to establish a defined notch, and wherein the inner pole piece and the outer pole piece are comprised of a magnetically permeable material and form a plurality of regions in the first air gap having high magnetic flux density.

26. The electromotive motor of claim 24 wherein a radial length of the second split-gap magnet is less than a radial length of each of the inner pole piece and the outer pole piece in the second composite structure to establish a defined notch, the inner pole piece and the outer pole piece comprised of a magnetically permeable material wherein a plurality of regions are defined in the second air gap having high magnetic flux density.

27. The electromotive motor of claim 25 wherein the first voice coil experiences a first electromotive force for driving a first diaphragm in a first vibrational direction in response to the generated electrical signal when placed in proximity to the plurality of regions in the first air gap having high magnetic flux density.

28. The electromotive motor of claim 26 wherein the second voice coil experiences a second electromotive force for driving a second diaphragm in a second vibrational direction in response to the generated electrical signal when placed in proximity to the plurality of regions in the second air gap having high magnetic flux density.

29. The electromotive motor of claim 24 wherein a direction of electrical signal flow in the first voice coil is normal to a direction of the magnetic field between one or more regions of high magnetic flux density in the first air gap, and wherein a direction of electrical signal flow in the second voice coil is normal to a direction of the magnetic field between one or more regions of high magnetic flux density in the second air gap, the direction of electrical signal flow in the first voice coil being the same as the direction of electrical signal flow in the second voice coil.

30. The electromotive motor of claim 25 wherein the housing includes at least one notch that is one of a rectangular shape or a chamfered shape and is located across the first air gap from the defined notch in the first composite structure.

31. The electromotive motor of claim 26 wherein the housing includes at least one notch that is one of a rectangular shape or a chamfered in shape and is located across the second air gap from the defined notch in the second composite structure.

32. The electromotive motor of claim 24 further comprising a spacer placed between the first side of the first magnet having the south-seeking pole and the horizontal portion of the housing, the spacer comprised of a magnetically permeable material.

33. The electromotive motor of claim 24 further comprising a spacer placed between the second side of the second magnet having the north-seeking pole and the horizontal portion of the housing, the spacer comprised of a magnetically permeable material.
